(19) United States
(12) Patent Application Publication
(10) Pub. No.: US 2023/0083826 A1
(43) Pub. Date: Mar. 16, 2023

(54) COMPUTER VISION APPROACHES FOR ENVIRONMENTALLY SUSTAINABLE AQUACULTURE

(71) Applicant: X Development LLC, Mountain View, CA (US)

(72) Inventor: Grace Calvert Young, Mountain View, CA (US)

(21) Appl. No.: 17/689,781

(22) Filed: Mar. 8, 2022

Related U.S. Application Data
(60) Provisional application No. 63/244,042, filed on Sep. 14, 2021.

(51) Int. Cl. A01K 61/13; G05B 13/02

(52) U.S. Cl. CPC A01K 61/13; G05B 13/0265

(57) ABSTRACT

Methods, systems, and apparatus, including computer programs encoded on computer-storage media, for environmentally sustainable aquaculture through computer vision for ectoparasite detection and medication dosing. In some implementations, actions include obtaining an image captured by an underwater camera; determining one or more fish detections and one or more ectoparasite detections based on the image; generating a filtered set of fish detections and ectoparasite detections; providing the filtered set of fish detections and ectoparasite detections to a trained model; and obtaining output of the trained model indicating an intensity of ectoparasite infection.

### CROSS REFERENCE TO RELATED APPLICATION

This application claims the benefit of U.S. Provisional Application No. 63/244,042, filed Sep. 14, 2021, the contents of which are incorporated by reference herein.

### FIELD

This specification generally relates to marine monitoring systems for environmentally sustainable aquaculture.

### BACKGROUND

Sea lice, as well as other parasites, feed on the mucus epidermal tissue and blood of host marine fish. Sea lice infestations can be a major problem in fish farming, because heavy infections can lead to deep lesions, particularly on the head region. Sea lice infestations can kill or render salmon unsuitable for market. Moreover, if sea lice are too plentiful, a farm can be required to shut down because of the effects on wild populations.

### SUMMARY

In general, innovative aspects of the subject matter described in this specification relate to the detection of ectoparasites, including marine ectoparasites, such as sea lice. In at least one implementation, an underwater camera system captures images of fish with sea lice. The images of fish are processed to detect fish shown in the images and to detect sea lice shown in the images. The detections of fish and detections of sea lice may be combined to more accurately detect sea lice infestations on fish.

More accurately detecting ectoparasite infestations may allow for treatment, such as medication, to be used more conservatively. For example, more accurate detection of sea lice infestations may reduce sea lice medication being used for false positive sea lice infestation detections, and may allow sea lice medication to be reduced to a minimum amount needed for a particular amount of infestation.

Conservatively using medication may be beneficial for the environment as medication may have a negative effect on an environment and wildlife. For example, the medication may inhibit growth in certain species of aquatic wildlife. When being used for treatment, the medication may be released into water that flows out of a fish pen and into surrounding ocean water. Accordingly, reducing usage of medication may reduce negative effects of medication on aquatic wildlife.

In aquaculture environments, dosage of medication is typically larger than required in order to ensure effectiveness. Overuse of medication can kill organisms within the surrounding ecosystem resulting in decay, algae blooms, oxygen deprivation, and further ecosystem collapse. By generating a more accurate dosage based on a more accurate determination of sea lice infestation, innovative aspects of the subject matter described in this specification effectively decrease the amount of medication used which prevents harm to the surrounding ecosystem.

Additionally. food sustainability is an important thread within climate change. Food production and distribution contribute an estimated one-third of all human-made greenhouse gas emissions. Furthermore, food-related emissions are expected to grow significantly, up to 30%, by 2050. Fish production, of which aquaculture represents almost 50%, contributes 17% of total animal protein. Aquaculture is also the fastest growing agricultural production system worldwide and is expected to continue outpacing other agriculture sectors.

Marine finfish aquaculture is already more sustainable than many other forms of animal protein with a relatively low feed conversion ratio (mass of input feed to mass of output meat) of 1-2.4, compared to beef 6-10, pork 2.7-4, and chicken 1.7-2. However, several considerations remain with respect to the sustainability of aquaculture operations: water quality impact from uneaten feed and other waste in surrounding waters; animal welfare in situations of overcrowding or disease; and carbon equivalent footprint of feed, which in some cases is sourced from wild-caught fish. These challenges, and the increasingly important role that aquaculture is expected to play in feeding the growing population over the next 30 years, demand innovative solutions.

Machine learning may be used to help address the above sustainability concerns for aquaculture through various processes including biomass estimation, parasite detection, including sea lice detection, as well as disease detection. Disease and parasite detection may be critical for early treatment and ensuring fish welfare. The data sets used to train and validate the models may be industrially relevant for aquaculture, including for salmon, seabass, trout, among others.

The details of one or more aspects described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram showing an example of a system for ectoparasite detection and medication dosing.

FIG. 2 is a diagram showing an example of a fish and ectoparasite detection by a system for sea lice detection.

FIG. 3 is a flow diagram illustrating an example of a process for ectoparasite detection.

Like reference numbers and designations in the various drawings indicate like elements.

### DETAILED DESCRIPTION

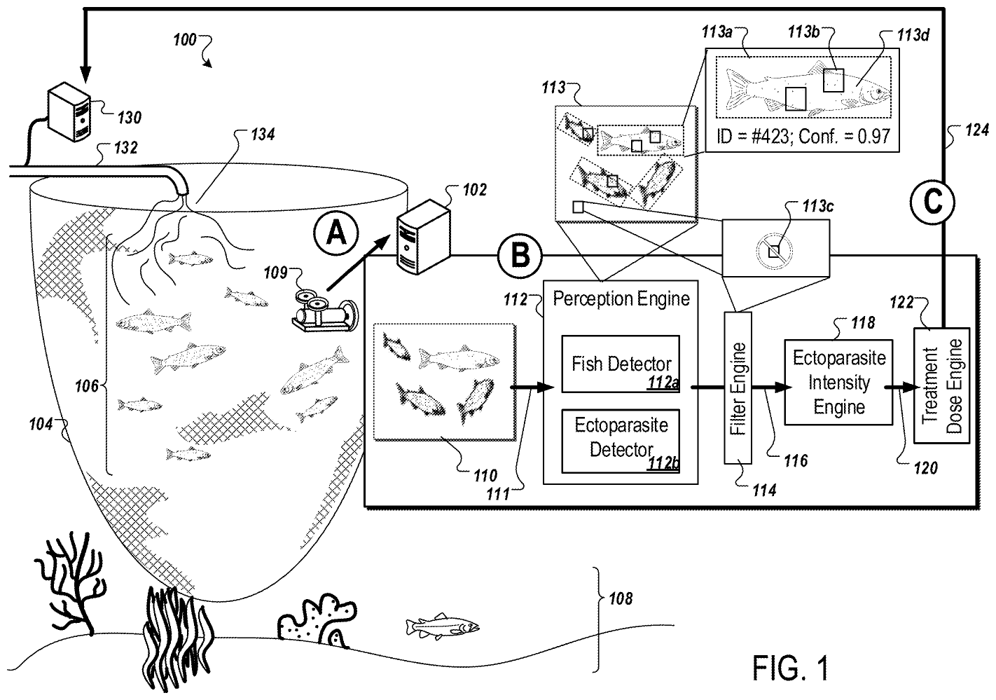

FIG. 1 is a diagram showing an example of a system 100 for ectoparasite detection and treatment such as medication dosing. The system 100 includes a control unit 102, a camera device 109, and a second control unit 130. The control unit 102 receives data captured by the camera device 109. The data includes images with spectral data across a range of the electromagnetic spectrum. For example, the spectral data may be representations of measured intensity in a spectrum that includes red, green, and blue light. The control unit 102 provides data to the second control unit 130 based on the control unit 102 processing the data received by the control unit 102. The second control unit 130 controls the medication dosing apparatus 132. The medication dosing apparatus 132 can include processors and mechanical elements configured to provide medication to one or more fish, scrub one or more fish, emit ultrasound directed at one or more fish, or perform other operations for removing or treating sea lice infestations.

Although the system 100 is described detecting sea lice, in other implementations, the system 100 detects other ectoparasites, such as monogeneans and trichodinid among others. In some implementations, the system 100 detects ectoparasites on non-aquatic animals, such as animals used as livestock. For example, the system 100 can detect ectoparasites, such as ticks, mites, or lice, among others, on cows, pigs, or the like. In some implementations, the camera device 109 is situated, or configured to maneuver, on land or in the air. For example, the camera device 109 can capture images of land animals, such as cows, to aid in detection and treatment of such land animals. In some implementations, the system 100 is used in agriculture. For example, the system 100 can be used to improve the treatment of livestock with ectoparasite infections.

In stage A, the control unit 102 receives one or more images from the camera device 109 including image 110. The camera device 109 moves around the fish pen 104 capturing images of the fish 106. The camera device 109 can be equipped with propellers or affixed to other automated mechanical systems, such as ropes, winches, pulleys, among others, to move around the fish pen 104.

In some implementations, the camera device 109 captures images using illuminators. For example, the camera device 109 can be equipped with illuminators that emit light in one or more ranges of wavelengths. The illuminators can be used to light a target depicted in the images captured by the camera device 109. For example, the camera device 109 can include a blue illuminator that emits light in the visible blue spectrum and a red illuminator that emits light in the visible red spectrum. The camera device 109 can capture images of fish as the illuminators alternate emitting light such that the camera device 109 captures some images of fish with a blue illuminator and some images of fish with a red illuminator. In general, any color illuminator, including non-visible ranges of the electromagnetic spectrum, can be used to light a target captured by the camera device 109.

When using illuminators that emit light with different frequencies, the objects detected by the camera device 109 can be detected in an image with a first frequency illuminator and an image with a second frequency illuminator. In general, the different illuminator frequencies cause different reflections on targets. The different reflections from the multiple frequencies can aid the control unit 102 in detecting and classifying objects and organisms within images captured by the camera device 109.

In stage B, the control unit 102 processes the image 110. The control unit 102 includes a perception engine 112, a filter engine 114, an ectoparasite intensity engine 118, and a treatment dose engine 122. The control unit 102 processes the image 110 using the perception engine 112. The perception engine 112 includes a fish detector 112a and an ectoparasite detector 112b. The fish detector 112a uses one or more machine learning models to determine regions of the image 110 that correspond to likely fish. The ectoparasite detector 112b uses one or more machine learning models to determine regions of the image 110 that correspond to likely sea lice.

Both the fish detector 112a and the ectoparasite detector 112b can be trained using relevant training data. For example, the fish detector 112a can be trained using known images of fish. The detectors can be trained using specific types of objects. For example, the control unit 102 can train the ectoparasite detector 112b using images of known types of sea lice. Corresponding learned models can then detect the different types of sea lice. For example, the ectoparasite detector 112b can detect male sea lice, female sea lice, mating sea lice, mobile sea lice, sea lice with eggs, sea lice without eggs, among others. Training data can include positive training data that include objects of interest, such as fish for the fish detector 112a and sea lice, including different types of sea lice, for the ectoparasite detector 112b. Training data can also include negative training data that does not include objects of interest. Both the fish detector 112a and the ectoparasite detector 112b can detect objects based on a single image or a group of sequential images such as video input.

The fish and sea lice detections are shown in item 113. Bounding box 113a indicates the detection of the fish 113d generated by the fish detector 112a. Detections can include identifications, such as alphanumerical identification strings, to indicate a particular fish. In the detection of the fish 113d, the identification is #423. If the control unit 102 detects the fish 113d again, the control unit 102 can assign the same identification to the detection. In this way, detections of the same object can be aggregated. In some cases, unique identifications are generated for each detection. In this way, each detection is recorded for later look up or analysis.

In some implementations, detections include confidence values. For example, the detection of the fish 113d has a confidence value of 0.97. A confidence value can include a score on a scale, such as a number between 0 and 1 or 0 and 100. Confidence values can indicate the likelihood that a given detection is accurate.

Sea detections on the fish 113d, including sea lice detection 113b, are generated by the ectoparasite detector 112b. In some cases, the sea lice detections can similarly include identifications and confidence values as shown for the detection of the fish 113d.

The detections of the perception engine 112 are provided to the filter engine 114 of the control unit 102. The filter engine 114 filters detections based on one or more rules. For example, as shown for sea lice detection 113c, the filter engine 114 removes sea lice detections that do not at least partially overlap with a fish detection. That is, because the sea lice indicated by the sea lice detection 113c is not overlapping with a fish, the sea lice detection 113c does not represent a sea louse attached to a fish. In this way, the control unit 102 can prevent false positives, such as debris in the water, from being counted as sea lice.

In some implementations, the filter engine 114 requires that detections be within a threshold distance from the camera device 109. For example, each detection can include a distance from the camera device 109 indicating how far the detected object is from the camera device 109. Distance can be measured by parallax, based on, e.g., the camera device 109 moving over time or from multiple cameras affixed to the camera device 109, environmental distortion, such as light dissipation in water, relative size of fish based on comparing the apparent size of the fish to an average size of fish, laser distance finding methods, among others.

In some implementations, the filter engine 114 removes sea lice detections unless the sea lice are detected in several frames on the same fish. For example, the filter engine 114 can obtain multiple detections from multiple images of fish. The filter engine 114 can determine, based on the characteristics of a given sea louse or its relative position on a fish, whether or not the sea louse is detected in a predetermined number of frames on the same fish. The filter engine 114 can compare the characteristics of sea lice, based on extracting characteristics, such as size, shape, color, spectral emission, among others, from the images of the sea lice to determine if the same sea lice are on the same fish over the course of two or more images. Similarly, the filter engine 114 can determine a location of each sea lice detection overlapping with a fish relative to the geometry of the fish. The filter engine 114 can repeat the operations to generate a series of sea lice locations relative to fish. Sea lice detections that are detected on the same fish and within a threshold distance from among the determined relative locations, can be counted as sea lice detections.

In some implementations, the filter engine 114 removes sea lice detections if the detection location and a lumpsucker location satisfies a distance threshold. For example, the control unit 102 can detect other objects, including lumpsuckers and other cleaner fish. Lumpsuckers eat the sea lice and serve as a natural way to remove them from the fish in the fish pen 104. If a lumpsucker, or other cleaning fish, is detected at a location within a determined threshold distance, such as 3 inches, from a location of a sea lice detection, the filter engine 114 can remove the corresponding sea lice detection. In this way, the control unit 102 can account for the fact that the cleaner fish tend to eat nearby sea lice and thereby remove the sea lice from the system.

The filtered detections 116 are provided to the ectoparasite intensity engine 118. The ectoparasite intensity engine 118 uses a linear regression to determine, based on a number of detected sea lice and a number of detected fish over a specified amount of time, a number of sea lice infections for the population of fish 106 in the fish pen 104.

In some implementations, the ectoparasite intensity engine 118 is trained based on historical sea lice infection data. For example, populations previously analyzed and treated for sea lice infections can be used to determine an accurate mapping of sea lice infections based on sea lice detections and fish detections. In some cases, results, such as effectiveness of sea lice medication, can indicate if a mapping of sea lice infections was accurate or not. If not accurate, a corresponding system can correct parameters of the linear regression to make the mapping more accurate. Updates to the parameters of the linear regression can be used to make analysis in multiple pens more accurate. For example, updates to the parameters can be pushed to a network connecting one or more control units and camera devices. Results used to update parameters for determining sea lice infection in one pen can be used to determine sea lice infection in another pen.

The system 100 relies on extrapolation from a subset of observations. In this way, the system 100 is more efficient than a system requiring an observation of each and every fish. However, efficiency, by reducing the number of observations, is inversely proportional to accuracy. In general, the accuracy of the system 100 depends on three variables: the number of observed fish, measurement error in the mapping models, and the variance of sea lice infections in observed fish.

In some implementations, the ectoparasite intensity engine 118 generates confidence intervals. For example, a confidence interval can be proportional to the variance, per observed fish, of sea lice infections. For example, if the control unit 102 determines a first fish has 2 sea lice infections and a second fish has 15 sea lice infections, the two observed fish would have a higher variance than two fish that were both observed and determined to have 1 sea lice infection.

A confidence interval can be inversely proportional to the number of fish observed. For example, if the camera device 109 obtains 100 images and provides the 100 images to the control unit 102 and the control unit 102 processes the 100 images to detect 500 fish, the number of fish observed by the control unit 102 would be 500. The confidence interval in this case would likely be smaller than a case where the number of observed fish is less than 500.

In some implementations, confidence intervals generated by ectoparasite intensity engine 118 indicate the range for the true average sea lice infections per fish in the fish pen 104. The confidence intervals can be generated to account for variables, including the number of observed fish, measurement error in the mapping models, and the variance of sea lice infections in observed fish, to provide an indication of accuracy to other related systems or users.

The ectoparasite intensity 120 is provided to the treatment dose engine 122. The treatment dose engine 122 can be configured based on a known treatment amount for each sea lice infection. For example, for a given type of sea lice medication, an amount for each infected fish can be obtained. The treatment dose engine 122 can scale the number of sea lice infections by the amount of medication needed for each sea lice infection. In some cases, the ectoparasite intensity 120 indicates an average of 2 sea lice infections per fish. If the medication required for treating 2 sea lice infections per fish is 1 cubic inch of medication, the treatment dose engine 122 can generate a dosage for the fish pen 104 of 1 cubic inch multiplied by the number of fish in the fish pen 104 of medication.

In some implementations, treatment dose engine 122 determines a dose of a non-medication-based treatment. For example, the system 100 can include an ectoparasite removal system, such as a physical ectoparasite removal system using ultrasonic waves to physically remove ectoparasites from animals. Similar to medication treatment, removal treatment can impact the surrounding environment through sound pollution of machines configured to operate for removal as well as energy consumption among others. The treatment dose engine 122 can determine a dosage of treatment to be administered by ectoparasite removal systems. In the ultrasonic case, the treatment dose engine 122 can limit the amount, or power, of ultrasonic waves emitted from an ultrasonic removal system. By limiting the treatment to only what is needed for recovery, the system 100 and the treatment dose engine 122 limit the negative effects caused by that treatment within the wider environment while maintaining efficacy.

In stage C, the control unit 102 provides a dosage 124 to the second control unit 130. In some implementations, the control unit 102 includes the second control unit 130. For example, the operations performed by the second control unit 130 are performed by the control unit 102. In some implementations, the second control unit 130 controls the medication dosing apparatus 132. In the example of FIG. 1, the medication dosing apparatus is a pipe that provides liquid medication 134 to the fish pen 104. In some cases, the medication dosing apparatus 132 can be an alternative system based on the type of medication delivered to the fish of the fish pen 104. In general, the medication dosing apparatus 132 can be configured to perform operations for removing or treating sea lice infestations.

The medication 134 is provided to the fish of the fish pen 104 in the amount specified by the treatment dose engine 122 based on the ectoparasite intensity 120 provided by the ectoparasite intensity engine 118. Because the sea lice infections are more accurately accounted for, based on the multi-step process of fish and sea lice detection followed by filtering and linear regression mapping, the resulting dosage is also more accurate, in that the dosage is closer to the minimum dosage that would still be effective.

Dosage of medication is typically larger than required in order to ensure effectiveness. Overuse of medication can kill organisms within the ecosystem 108 resulting in decay, algae blooms, oxygen deprivation, and further ecosystem collapse. By generating a more accurate dosage based on a more accurate determination of sea lice infection, the system 100 effectively decreases the amount of medication used which prevents harm to the surrounding ecosystem 108.

In some implementations, medication of fish is combined with removal of fish from the fish pen 104. For example, if one or more fish provide an amount of sea lice infections above a threshold, the control unit 102 can determine that the one or more fish are to be removed from the fish pen 104. The one or more fish can receive targeted treatment which may be separated from the surrounding ecosystem thereby reducing any harmful effects. The one or more fish can also be used for applications where sea lice infection below a threshold level is permitted.

The control unit 102 can send a signal to a control unit, or can send the signal itself, configured to activate a sorting mechanism. The sorting mechanism can include current generates, such as propellers or fans, flaps, winches, ropes, among others, configured to sort one or more fish from a population. In some implementations, the control unit 102 controls the sorting mechanism and sends a signal configured to sort one or more fish from the fish pen 104 to another location to receive specific treatment. In this way, the amount of medication may be further reduced thereby further reducing any harmful impacts on the surrounding ecosystem.

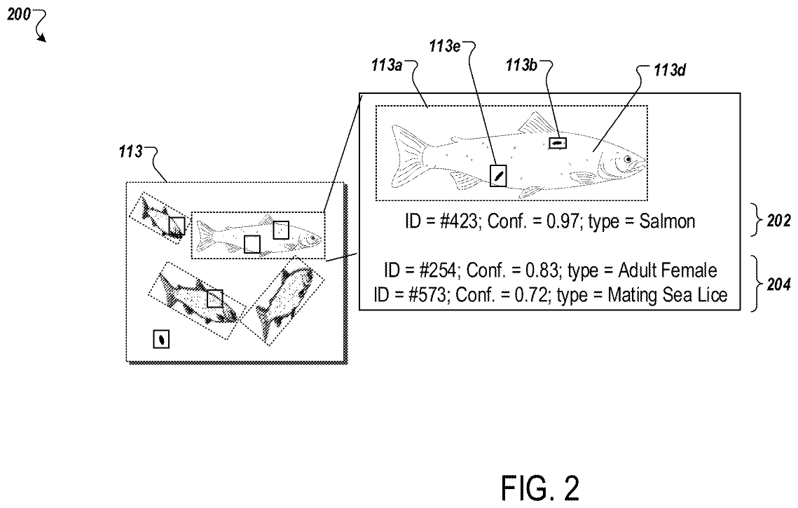

FIG. 2 is a diagram showing an example of a fish and ectoparasite detection by a system for ectoparasite detection. FIG. 2 shows, in greater detail, the detections shown in item 113 of FIG. 1. For example, FIG. 2 includes information for sea lice detections 113b and 113e. Data 202 indicates information of the fish detection of 113a including a type of fish, in this case, salmon. In general, the fish detector 112a can be trained to identify any type or types of fish, including salmon and trout. Data 204 indicates information of the sea lice detections 113b and 113e. Each sea lice detection can include, similar to the fish detection 113a, a confidence value and an identifier that can include letters and numerals and can be unique to the particular detection. The sea lice detections can further include a type of sea lice such as male sea lice, female sea lice, adult sea lice, juvenile sea lice, mating sea lice, mobile sea lice, sea lice with eggs, sea lice without eggs, combinations of multiple types, among others.

In general, the effect on the ectoparasite intensity 120, for each sea lice detection, can depend on the type of sea lice. For example, in some implementations, female sea lice with eggs will increase the resulting ectoparasite intensity 120 more than a detection of juvenile sea lice. In some implementations, a hierarchy of effects can be provided by a user indicating what types of sea lice are more indicative of sea lice infestation within a fish pen. In some implementations, one or more machine learning models can, based on historical sea lice detections and actual sea lice infestation statistics, generate values to weight the detections of sea lice based on type. For example, one or more models can generate larger weights for detections of sea lice with eggs and smaller weights for detections of sea lice without eggs. In this way, a system, such as the system 100 of FIG. 1, can account for the likelihood that the eggs of the female will soon become sea lice.

The filtered set of detections 116 can include a type corresponding to each fish or sea lice detection and provide the filtered set of detections 116 to the ectoparasite intensity engine 118. In some implementations, the ectoparasite intensity engine 118 includes a pre-processing step of converting the types of detections into corresponding sea lice detections. For example, the ectoparasite intensity engine 118 can apply weightings to one or more detections based on the type of a given detection in order to determine a weighted amount of sea lice. The ectoparasite intensity engine 118 can then use the weighted value in the mapping to an ectoparasite intensity 120. In some implementations, the ectoparasite intensity engine 118 can use filtered set of detections 116 with indications of types of one or more detections directly in the mapping to an ectoparasite intensity 120. For example, one or more trained models of the ectoparasite intensity engine 118 can be trained to, based on receiving input of one or more detections and corresponding types, output an ectoparasite intensity 120 based on historical training data of detections, types, and sea lice infestations.

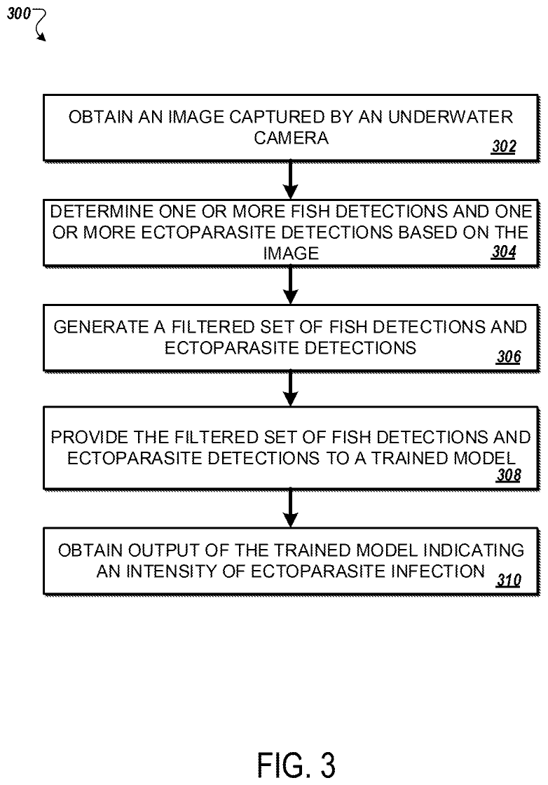

FIG. 3 is a flow diagram illustrating an example of a process 300 for ectoparasite detection and medication dosing. The process 300 may be performed by one or more electronic systems, for example, the system 100 of FIG. 1.

The process 300 includes obtaining an image captured by an underwater camera (302). For example, the camera device 109 can obtain one or more images of the fish 106 in the fish pen 104. The camera device 109 can provide the one or more images to the control unit 102 for processing.

The process 300 includes determining one or more fish detections and one or more ectoparasite detections based on the image (304). For example, the control unit 102 obtains one or more images of the fish provided by the camera device 109 and processes the one or more images. The control unit 102 can process the images using the perception engine 112 including the fish detector 112a and the ectoparasite detector 112b. By using the fish detector 112a and the ectoparasite detector 112b, the control unit 102 can detect one or more fish and one or more sea lice within the images obtained from the camera device 109.

The process 300 includes generating a filtered set of fish detections and ectoparasite detections (306). For example, the control unit 102 uses the filter engine 114 to generate a filtered set of detections 116. The filter engine 114 can operate according to one or more predetermined rules. For example, the filter engine 114 can determine the location of one or more sea lice detections. The filter engine 114 can determine the location of one or more fish. The filter engine 114 can determine if any sea lice detections are not overlapping with a fish detection and remove those non-overlapping detections.

The process 300 includes providing the filtered set of fish detections and ectoparasite detections to a trained model (308). For example, the ectoparasite intensity engine 118 of the control unit 102 generates the ectoparasite intensity 120 based on the filtered data set of detections generated by the filter engine 114. The ectoparasite intensity engine maps, using a linear regression, or other suitable model, a number of detections of ectoparasite and fish to an intensity of ectoparasite infections.

The process 300 includes obtaining output of the trained model indicating an intensity of ectoparasite infection (310). For example, the control unit 102 generates the ectoparasite intensity 120. The ectoparasite intensity 120 can include an average number of sea lice infections per fish. The ectoparasite intensity 120 can be used by the treatment dose engine 122 of the control unit 102 to determine a more accurate treatment dosage for more ecologically responsible ectoparasite mediation.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback;

and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

What is claimed is:

1. A method comprising obtaining an image captured by an underwater camera;
determining one or more fish detections and one or more ectoparasite detections based on the image;
generating a filtered set of fish detections and ectoparasite detections;
providing the filtered set of fish detections and ectoparasite detections to a trained model; and
obtaining output of the trained model indicating an intensity of ectoparasite infection.

2. The method of claim 1, comprising:
generating a medication dosage based on the intensity of ectoparasite infection;
and providing an indication of the medication dosage to a medication dosing apparatus.

3. The method of claim 1, wherein the trained model is a linear regression mapping a number of fish detections and a number of ectoparasite detections in the filtered set of fish detections and ectoparasite detections to the intensity of ectoparasite infection.

4. The method of claim 1, comprising:
detecting a location of a cleaner fish; and
generating the filtered set of fish detections, wherein the filtered set of fish detections and ectoparasite detections do not include an ectoparasite detection satisfying a threshold distance from the location of the cleaner fish.

5. The method of claim 1, comprising:
detecting a location of an ectoparasite detection;
determining the location of the ectoparasite detection relative to a location of the underwater camera satisfies a distance threshold; and
generating the filtered set of fish detections, wherein the filtered set of fish detections and ectoparasite detections do not include the ectoparasite detection satisfying the distance threshold.

6. The method of claim 1, comprising:
detecting a location of a fish detection;
determining the location of the fish detection relative to a location of the underwater camera satisfies a distance threshold; and
generating the filtered set of fish detections and ectoparasite detections, wherein the filtered set of fish detections and ectoparasite detections do not include the fish detection satisfying the distance threshold.

7. The method of claim 1, wherein generating the filtered set of fish detections and ectoparasite detections comprises:
determining an area corresponding to a location of a first ectoparasite detection;
determining the area of the first ectoparasite detection does not overlap with areas of any fish detections; and
generating the filtered set of fish detections, wherein the filtered set of fish detections and ectoparasite detections do not include the first ectoparasite detection.

8. A system comprising one or more computers and one or more storage devices on which are stored instructions that are operable, when executed by the one or more computers, to cause the one or more computers to perform operations comprising:
obtaining an image captured by an underwater camera;
determining one or more fish detections and one or more ectoparasite detections based on the image;
generating a filtered set of fish detections and ectoparasite detections;
providing the filtered set of fish detections and ectoparasite detections to a trained model; and
obtaining output of the trained model indicating an intensity of ectoparasite infection.

9. The system of claim 8, wherein the operations comprise:
generating a medication dosage based on the intensity of ectoparasite infection; and
providing an indication of the medication dosage to a medication dosing apparatus.

10. The system of claim 8, wherein the trained model is a linear regression mapping a number of fish detections and a number of ectoparasite detections in the filtered set of fish detections and ectoparasite detections to the intensity of ectoparasite infection.

11. The system of claim 8, wherein the operations comprise:
detecting a location of a cleaner fish; and
generating the filtered set of fish detections, wherein the filtered set of fish detections and ectoparasite detections do not include an ectoparasite detection satisfying a threshold distance from the location of the cleaner fish.

12. The system of claim 8, wherein the operations comprise:
detecting a location of an ectoparasite detection;
determining the location of the ectoparasite detection relative to a location of the underwater camera satisfies a distance threshold; and
generating the filtered set of fish detections, wherein the filtered set of fish detections and ectoparasite detections do not include the ectoparasite detection satisfying the distance threshold.

13. The system of claim 8, wherein the operations comprise:
detecting a location of a fish detection;
determining the location of the fish detection relative to a location of the underwater camera satisfies a distance threshold; and
generating the filtered set of fish detections and ectoparasite detections, wherein the filtered set of fish detections and ectoparasite detections do not include the fish detection satisfying the distance threshold.

14. The system of claim 8, wherein generating the filtered set of fish detections and ectoparasite detections comprises:
determining an area corresponding to a location of a first ectoparasite detection;
determining the area of the first ectoparasite detection does not overlap with areas of any fish detections; and
generating the filtered set of fish detections, wherein the filtered set of fish detections and ectoparasite detections do not include the first ectoparasite detection.

15. A non-transitory computer storage medium encoded with instructions that, when executed by one or more computers, cause the one or more computers to perform operations comprising:
obtaining an image captured by an underwater camera;
determining one or more fish detections and one or more ectoparasite detections based on the image;
generating a filtered set of fish detections and ectoparasite detections;
providing the filtered set of fish detections and ectoparasite detections to a trained model; and
obtaining output of the trained model indicating an intensity of ectoparasite infection.

16. The non-transitory computer storage medium of claim 15, comprising:
generating a medication dosage based on the intensity of ectoparasite infection; and
providing an indication of the medication dosage to a medication dosing apparatus.

17. The non-transitory computer storage medium of claim 15, wherein the trained model is a linear regression mapping a number of fish detections and a number of ectoparasite detections in the filtered set of fish detections and ectoparasite detections to the intensity of ectoparasite infection.

18. The non-transitory computer storage medium of claim 15, comprising:
detecting a location of a cleaner fish; and
generating the filtered set of fish detections, wherein the filtered set of fish detections and ectoparasite detections do not include an ectoparasite detection satisfying a threshold distance from the location of the cleaner fish.

19. The non-transitory computer storage medium of claim 15, comprising:
detecting a location of an ectoparasite detection;
determining the location of the ectoparasite detection relative to a location of the underwater camera satisfies a distance threshold; and
generating the filtered set of fish detections, wherein the filtered set of fish detections and ectoparasite detections do not include the ectoparasite detection satisfying the distance threshold.

20. The non-transitory computer storage medium of claim 15, comprising:
detecting a location of a fish detection;
determining the location of the fish detection relative to a location of the underwater camera satisfies a distance threshold; and
generating the filtered set of fish detections and ectoparasite detections, wherein the filtered set of fish detections and ectoparasite detections do not include the fish detection satisfying the distance threshold.
